(19) United States
(12) Patent Application Publication
(10) Pub. No.: US 2019/0000595 A1
(43) Pub. Date: Jan. 3, 2019

(54) CEMENTLESS, SCREWLESS DENTAL ABUTMENT SYSTEM AND METHOD OF RELEASE

(71) Applicant: Paul Kenneth Clark, JR., Heber City, UT (US)

(72) Inventor: Paul Kenneth Clark, JR., Heber City, UT (US)

(21) Appl. No.: 15/641,152

(22) Filed: Jul. 3, 2017

(51) Int. Cl. A61C 8/00

(52) U.S. Cl. CPC A61C 8/0071; A61C 8/0012; A61C 8/006; A61C 8/0022

(57) ABSTRACT

A Morse taper dental implant providing two or more Morse taper interactions to secure a dental abutment within an implant and beneath a prosthesis. The implant (or anchor) penetrates the jawbone. The abutment having a conical male Morse taper component positions within a female socket forming part of a prosthesis. The abutment comprises an abutment platform from which a conical male Morse taper component extends for creating a second Morse taper interaction with a female socket. At least one aperture forms in the female socket to enable an implement to pass through for engaging the abutment, so as to release the Morse taper interaction(s).

### FIELD OF THE INVENTION

This invention relates to a Morse taper dental implant abutment system and method of release. The first Morse taper interaction is between the abutment and implant and the second Morse taper interaction is between a tapered female cap and the abutment, providing a retrievable and releasable abutment system.

### BACKGROUND

### Description of the Related Art

Dental implants have been developed in order to restore lost teeth and restore chewing functionality to patients. Dental implant serves to mimic a root structure and protrudes through the gum of a patient's mouth to hold a prosthesis.

A Morse taper coupling may be made between the implant and the abutment inserted therein. The abutment usually exhibits a truncated-cone shank or tang to be forced into a corresponding Morse-tapered female cavity formed inside the implant. A Morse taper interaction, or cold weld, between two conical, tapered components, one male and one female, is activated by axial or impulsive forces exerted using a tool, drift or implement. To release or disengage the Morse taper, it is most common to apply torsional axial force, though brut longitudinal tensional force may also be applied.

Typically, when a dental implant is used, an artificial abutment is received by the implant which abutment then carries the visible prosthesis such as a crown connected to the abutment or with a screw-retained system. Tube and screw abutment types are known in the art, but there exists no efficient cementless and screwless means in the art of securing a prosthesis to an abutment using Morse tapers. Although Morse tapers have been used in the art to secure an abutment to an implant, an efficient dual Morse taper assembly is unknown. Many abutments are adapted to dispose in the implant to prevent abutment rotation relative to the implant over time caused by chewing; however, by restricting axial rotation, this same adaptation prevents efficient insertion and retrieval of the abutment using a Morse taper. This shortcoming and others are solved by the present invention.

### SUMMARY

From the foregoing discussion, it should be apparent that a need exists for a dual Morse taper dental implant assembly and method of release. Beneficially, such an assembly would provide a dental implant that forms Morse taper interactions to secure a prosthesis, and also provide facilitated access to the crown for detachment of the Morse taper that is holding the crown in place.

The present invention has been developed in response to the present state of the art, and in particular, in response to the problems and needs in the art that have not yet been fully solved by currently available dental implants. Accordingly, the present invention has been developed to provide a dual Morse taper dental implant, the dental implant comprising: a cylindrical implant comprising a threaded outer surface, the threaded outer surface being notched, wherein the implant defines a hollow interior cavity for receiving and mating with a tapered abutment; a tapered abutment comprising: a conical narrow abutment end, the narrow abutment end adapted to position within the hollow interior cavity and form a Morse taper friction fit with the implant, a shaft extending below the narrow abutment end, an abutment platform disposed between the implant and a female socket; a conical male component upwardly protruding from the abutment platform, the male component adapted to position within a hollow recess defined by the female socket and form a Morse taper friction fit, a socket head disposed above the male component; a conical female socket defining a hollow interior recess for receiving and mating with the male component of the abutment and for forming a Morse taper connection therewith, the female socket component defining one or more apertures adapted to allow a user to engage the female socket component with an implement adapted to release the Morse taper friction fit; wherein the female socket component defines an open top aperture; and a crown affixed to an exterior surface of the female socket component.

The implant may further comprise a tooth-like prosthesis defining a hollow interior cavity for mating with an outer conical surface of the female socket. The tooth-like prosthesis may mate, in some embodiments, with the outer conical surface of the female socket using a Morse taper friction fit.

The open top aperture may be hexagonal in shape through a cross section and adapted to apply torsional force to the female socket component when engaged with a male hexagonal implement.

A lingual side of the female socket may define a threaded aperture for engagement with a plunger. The tool may pass through the at least one aperture in the female socket to engage the socket head.

The tool may engage the axial bore to release the Morse taper friction fit between the female socket and the abutment. The implant and abutment may be fabricated from titanium.

The female socket may define two diametrically opposed apertures on the outer surface. The socket head may be a hexagonal head. The abutment may further comprise an uninterrupted flange disposed above the socket head.

The shaft may comprise a tang.

A second Morse taper dental implant is also provided, the dental implant comprising: a cylindrical implant comprising a threaded outer surface, the threaded outer surface being notched, wherein the implant defines a hollow interior cavity for receiving and mating with an abutment; a tapered abutment comprising: an abutment platform disposed between the implant and a female socket; a conical male component upwardly protruding from the abutment platform, the male component adapted to position within a hollow recess defined by the female socket and form a Morse taper friction fit therewith, a socket head disposed above the male component, the socket head defining an axial bore; a female socket defining a hollow interior recess for receiving and mating with the male component of the abutment and for forming a Morse taper connection therewith, the female socket component defining one or more apertures adapted to allow a user to engage the female socket component with an implement adapted to release the Morse taper friction fit; and a crown affixed to an exterior surface of the female socket component.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a top side perspective view illustrating one embodiment of a dual Morse taper dental implant assembly, in accordance with the present invention;

FIG. 2 is a side perspective view illustrating a disassembled dual Morse taper dental implant assembly in accordance with the present invention;

FIG. 3 is a side view illustrating the dual Morse taper dental implant assembly with the tapered female cap removed in accordance with the present invention;

FIG. 4 is a side perspective view illustrating the dual Morse taper dental implant assembly in accordance with the present invention;

FIG. 5 is a top view illustrating the dual Morse taper dental implant assembly in accordance with the present invention;

FIG. 6 is an upper angle perspective view illustrating the dual Morse taper dental implant assembly in accordance with the present invention;

FIG. 7 is a bottom view illustrating the dual Morse taper dental implant assembly in accordance with the present invention; and

FIG. 8 is a lower angle perspective view illustrating the dual Morse taper dental implant assembly in accordance with the present invention

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

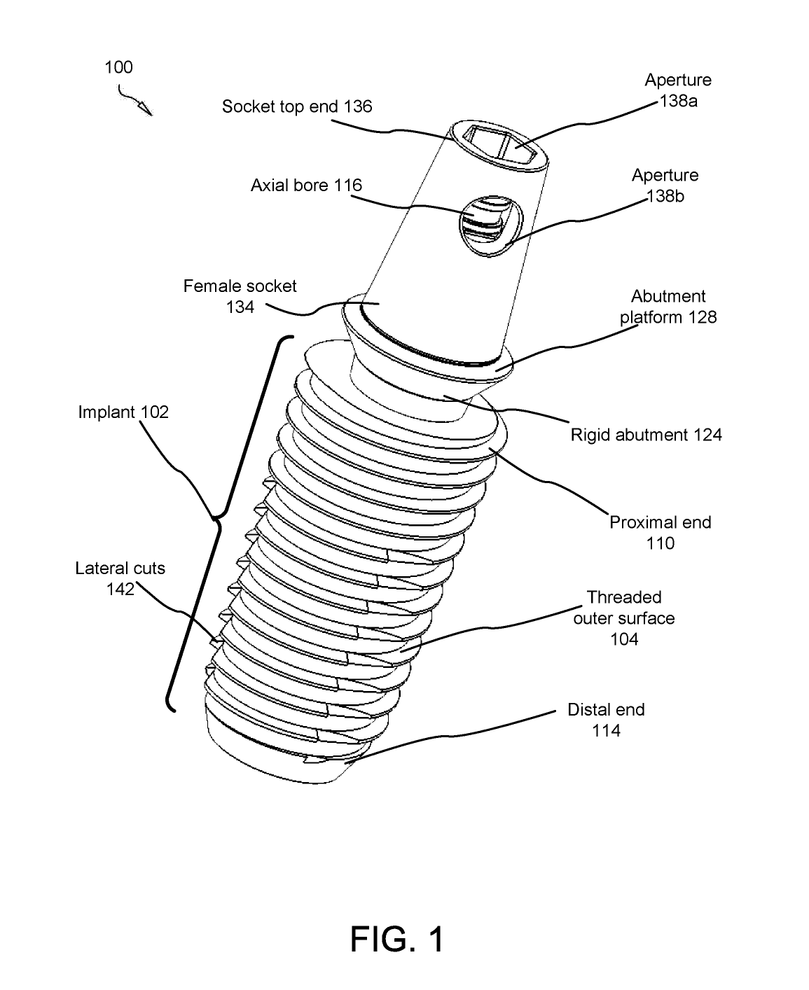

FIG. 1 depicts a dual Morse taper dental implant assembly 100. Beneficially, such an assembly 100 would provide a dental implant that forms two or more (potentially three) separate Morse taper interactions to secure an abutment to implant 102 and a crown or prosthesis to the abutment. The assembly 100 also provides facilitated access to the crown through at least one aperture 138a-c with a tool or implement for detachment of the crown or prosthesis from the Morse taper interconnection that is holding the crown to the abutment as well as the same or a separate implement for releasing a Morse taper interactions between the abutment and the implant.

The present invention has been developed in response to the present state of the art, and in particular, in response to the problems and needs in the art that have not yet been fully solved by currently available dental implants. Accordingly, the present invention has been developed to provide a Morse taper dental implant assembly that overcomes many or all of the above-discussed shortcomings in the art.

In some embodiments, a dual or treble Morse taper dental implant assembly 100, hereafter “assembly 100” provides two or more Morse taper interactions. In one embodiment, the assembly 100 includes a first Morse taper interaction between an implant 102 and a tapered and conical abutment 124 and also forms a second Morse taper interaction between a female socket 134 or female cap 134 and the abutment 124.

A crown is affixed using means known to those of skill in the art to the exterior of the socket or female cap 134. For removal of the crown, one or more holes are drilled in the crown, and a tool or drift passes through the hole and an aperture 138a, 138b, 138c in the tapered cap 132 to engage the axial bore 116. By manipulating a socket head 120 on the axial bore 116, the Morse taper interaction between the female cap 134 and the crown 140 is forcibly overcome, so as to remove the crown 140 from the female socket 134.

Those skilled in the art will recognize that a Morse taper is formed when two substantially identical conically-shaped components mate or engage with one another. This engagement creates a strong surface collision to form a snug, but detachable interconnection or cold weld. Further, an interference, such as a gap between the surfaces further strengthens the surface collision. It is also known in the art that a Morse taper provides a hermetic seal that bacteria cannot break through. This leads to less microbial ingress and less bone resorption and loss.

The implant 102 comprises a threaded outer surface 104 as shown. This threaded outer surface 104 is notched or contains lateral cuts 142 for securing the implant 102 in bone.

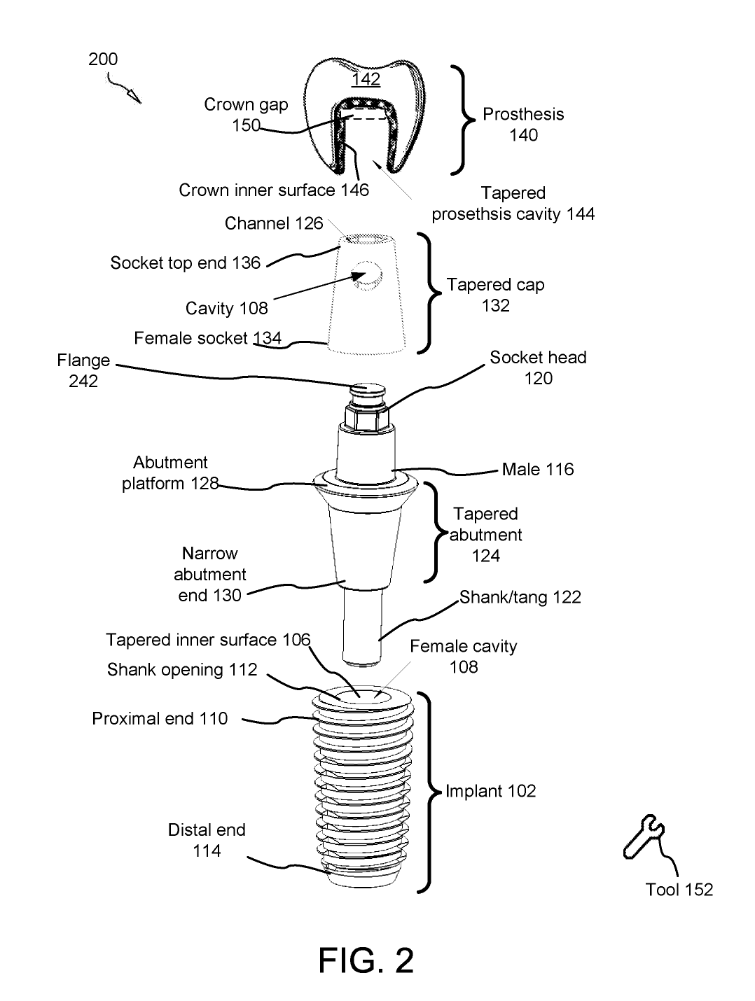

Turning now to FIG. 2, the assembly 200 comprises an implant 102 comprising a cylindrical or conical implant 102 and a threaded outer surface 104 having a threaded configuration and a tapered inner surface 106. The threaded outer surface 104 is adapted to drill into a jaw bone, as known in the art. The threaded outer surface 104 comprises a plurality of notches or lateral cuts 142 in the threads to prevent axial movement of the anchor 102 when positions within bone. The implant 102 comprises a tapered inner surface 106 defining a hollow interior cylindrical or conical cavity acting as a female receiving component for forming a Morse taper with a corresponding tapered narrow abutment end 130.

The tapered inner surface 106 mates with the abutment 124 to form a Morse taper. The implant 102 has a distal end 114 which is sunk into a jawbone and a proximal end which mates with the rigid abutment 124 and/or the abutment platform 128. Suitable materials for manufacturing the implant 102 and the abutment 124 may include, without limitation, titanium, aluminum, stainless steel, polymers, and metal alloys.

In some embodiments, the assembly 100 comprises a socket head 120 having an axial bore 116 circumscribing the socket head 120. In one embodiment, the socket head 120 is a hexagonal head. In other embodiments, any type of capping or socket member may be used.

In various embodiments, the socket head 120 includes a flange 242 disposed above the hexagonal socket head. The flange 242 and socket head 120 forms an annual recess for receiving and securing a polymeric O-ring for dampening lateral forces between the female socket 134 and the socket head 120.

In various embodiments, a shank 122 (or tang 122) juts downwardly from the narrow abutment end 130.

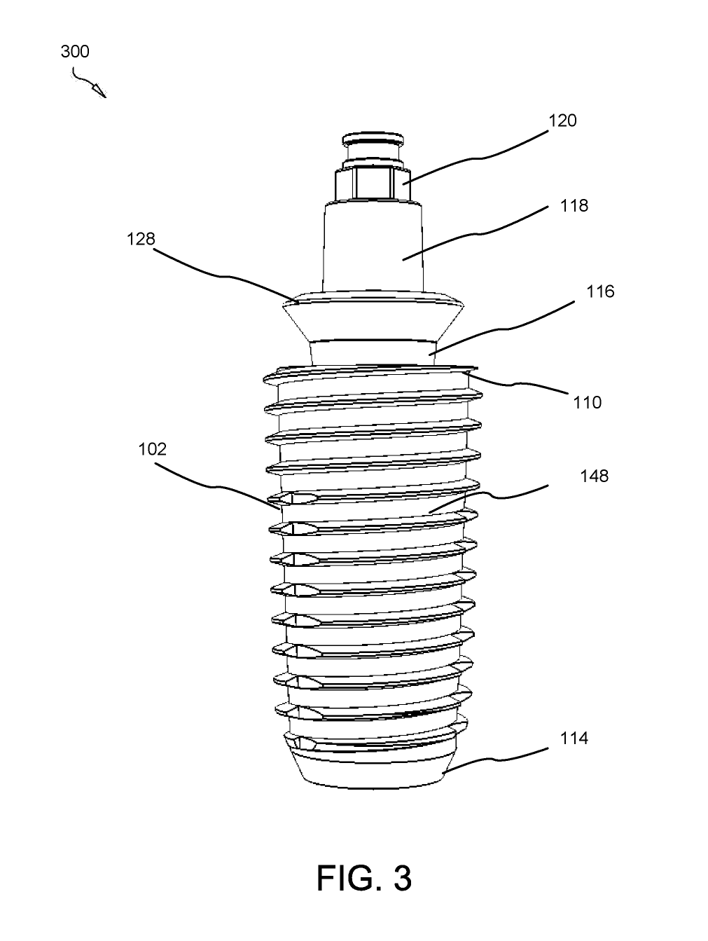

As FIG. 3 shows, the male component 118 of the abutment (the narrow tapered or conical end) at least partially positions within a tapered cavity 108 defined by the female socket 134. The axial bore 116 forms a firm fit inside the shank cavity 108. The abutment platform 128 juts upwards slightly from the top end of the implant 102.

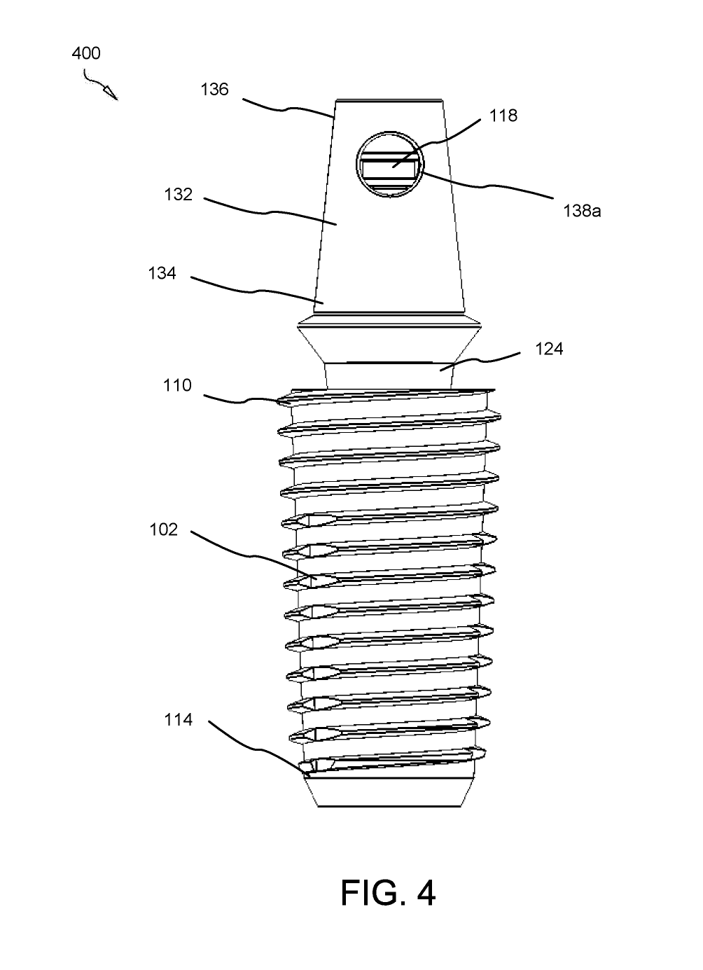

Turning now to FIG. 4, the assembly 100 comprises a tapered abutment 124 which positions within the implant 102 (also called an anchor 102). The tapered abutment 124 comprises a platform 128 disposed above the implant 102. The narrow abutment end 130 forms a snug interconnection with the tapered inner surface 106 of the implant 102 in accordance with the Morse taper configuration. Suitable materials for the tapered abutment 124 and female socket 134, as mentioned previously, may include, without limitation, titanium, polymers, and metal alloys.

Additionally, a shank gap 148 may form between the tapered inner surface 106 of the anchor 102 and the narrow abutment end 130 of the tapered abutment 124. In one embodiment, the shank gap is about ¼ of a thousandth of an inch, although other widths are equally possible. In operation, the shank gap creates an interference that increases the surface collision between the tapered inner surface 106 and the narrow abutment end 130.

The interference from such a gap is a unique to the Morse taper. In this manner, the Morse taper connection between the tapered inner surface 106 and the narrow abutment end 130 creates a snug interlocking relationship between the implant 102 and the tapered abutment 124. Furthermore, because of the Morse taper, the tapered abutment 124 self-aligns against the implant 102.

The same is true for the male component 118 of the abutment 124 which mates with the female component 134 forming a Morse taper coupling. A prosthesis 140 is affixed to the exterior conical surface of the female component 134 and released when the Morse taper cold weld between the male component 116 and the female component 134 is released through disengagement.

As shown, the assemblies 100-400 may include a tapered cap 132 comprising a narrow top end and wide bottom end.

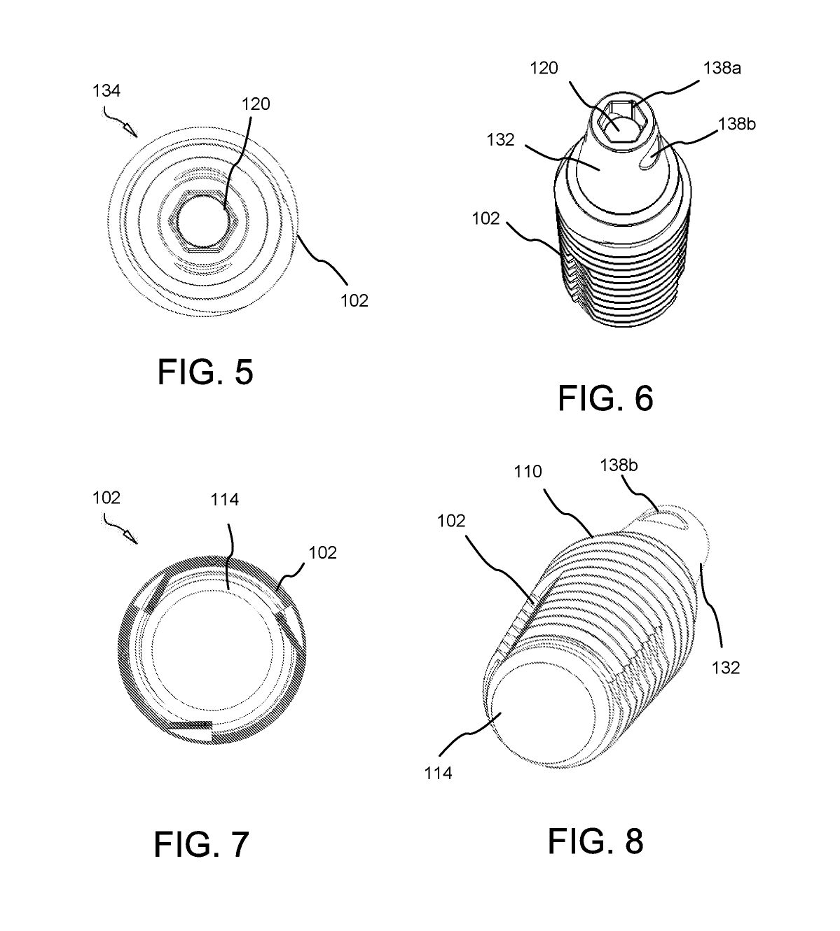

Looking now at FIGS. 5, 6 and 7, the narrow cap end 136 is defined by at least one aperture 138a, 138b, 138c. The aperture 138a-c allows passage of a tool for decoupling a crown or prosthetis 140 from the female cap 134. In one embodiment, the at least one aperture 138a-c comprises two diametrically opposed apertures 138b, 138c formed in the sidewalls of the tapered cap 132 (or female socket 134), and a single aperture 138a formed at the terminus of the tapered cap 132. In this manner, hole can be drilled in the crown 140 in alignment with the aperture 138a-c, and the implement or tool 152 can engage the socket head 120 of the axial bore 116 through the drilled hole and aperture 138a-c.

Looking back at FIG. 2, the assembly 200 may include a crown 140 defined by an exterior surface 142 and a crown inner surface 146. In one embodiment, the crown 140 is a dental prosthetic device. The crown inner surface 146 forms a Morse taper, and is defined by a crown cavity 144. The crown 140 fits over the tapered cap 132 and female component 132.

Additionally, a crown gap 150 forms between the crown inner surface 146 and the narrow cap end 136 of the tapered cap 132. A subsequent (and potentially third) Morse Taper interaction may be used to cold weld the crown 140 to an exterior surface of the female socket 134.

In some embodiments, the implant or assembly 200 further comprises a tool, implement or drift, such as an appropriately sized and dimensioned socket wrench, for engaging the socket head 120 of the axial bore 116. The tool can press against the aperture 138 to dislodge the crown.

A method 900 (not shown) for removing the crown 140 is also provided. The method 900 in the disclosed embodiments substantially includes the steps necessary to carry out the functions presented above with respect to the operation of the described assembly 100. In one embodiment, the method 900 includes an initial Step 902 of anchoring an anchor 102 into a jaw bone, the anchor 102 comprising a threaded outer surface 104 and a tapered inner surface 106 that forms a Morse taper. In some embodiments, the second shank end 114 may anchor the shank 102 into the jaw through various means known in the art. This will leave the first shank end 110, and the shank opening 112 exposed above the jaw.

Another Step 908 may include forming a snug interconnection between the narrow abutment end 130 and the tapered inner surface of the anchor 102. The Morse taper creates a large surface collision that forms this strong interaction. Furthermore, a shank gap 148 creates interference that further enhances the surface collision therebetween.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A dual Morse taper dental implant abutment assembly, the assembly comprising:
a cylindrical implant comprising a threaded outer surface, the threaded outer surface being notched, wherein the implant defines a hollow interior cavity for receiving and mating with a tapered abutment;
a tapered abutment comprising:
a conical narrow abutment end, the narrow abutment end adapted to position within the hollow interior cavity and form a Morse taper friction fit with the implant,
a shaft extending below the narrow abutment end,
an abutment platform disposed between the implant and a female socket;
a conical male component upwardly protruding from the abutment platform, the male component adapted to position within a hollow recess defined by the female socket and form a Morse taper friction fit,
a socket head disposed above the male component;
a conical female socket defining a hollow interior recess for receiving and mating with the male component of the abutment and for forming a Morse taper connection therewith, the female socket component defining one or more apertures adapted to allow a user to engage the female socket component with an implement adapted to release the Morse taper friction fit;
wherein the female socket component defines an open top aperture; and
a crown affixed to an exterior surface of the female socket component.

2. The assembly of claim 1, further comprising a tooth-like prosthesis defining a hollow interior cavity for mating with an outer conical surface of the female socket.

3. The assembly of claim 2, wherein the tooth-like prosthesis mates with the outer conical surface of the female socket using a third Morse taper friction fit.

4. The assembly of claim 1, wherein the open top aperture is hexagonal in shape through a cross section and adapted to apply torsional force to the female socket component when engaged with a male hexagonal implement.

5. The assembly of claim 1, wherein a lingual side of the female socket defines a threaded aperture for engagement with a plunger.

6. The assembly of claim 2, wherein the tool passes through the at least one aperture in the female socket to engage the socket head.

7. The assembly of claim 6, wherein the tool engages the axial bore to release the Morse taper friction fit between the female socket and the abutment.

8. The assembly of claim 1, wherein the implant and abutment are fabricated from titanium.

9. The assembly of claim 1, wherein the female socket component defines two diametrically opposed apertures on the outer surface.

10. The assembly of claim 1, wherein the socket head is a hexagonal head.

11. The assembly of claim 1, wherein the abutment further comprises an uninterrupted flange disposed above the socket head.

12. The assembly of claim 1, wherein the shaft comprises a tang.

13. A Morse taper dental implant abutment assembly, the assembly comprising:
a cylindrical implant comprising a threaded outer surface, the threaded outer surface being notched, wherein the implant defines a hollow interior cavity for receiving and mating with an abutment;
a tapered abutment comprising:
an abutment platform disposed between the implant and a female socket;
a conical male component upwardly protruding from the abutment platform, the male component adapted to position within a hollow recess defined by the female socket and form a Morse taper friction fit therewith,
a socket head disposed above the male component, the socket head defining an axial bore;
a female socket defining a hollow interior recess for receiving and mating with the male component of the abutment and for forming a Morse taper connection therewith, the female socket component defining one or more apertures adapted to allow a user to engage the female socket component with an implement adapted to release the Morse taper friction fit; and
a crown affixed to an exterior surface of the female socket component.

14. A Morse taper dental implant abutment assembly, the assembly comprising:
a cylindrical implant comprising:
a threaded outer surface, the threaded outer surface being notched, wherein the implant defines a hollow interior cavity for receiving and mating with an abutment;
an abutment platform disposed between the implant and a female socket;
a conical male component upwardly protruding from the abutment platform, the male component adapted to position within a hollow recess defined by the female socket and form a Morse taper friction fit therewith,
a socket head disposed above the male component, the socket head defining an axial bore;
a female socket defining a hollow interior recess for receiving and mating with the male component of the abutment and for forming a Morse taper connection therewith, the female socket component defining one or more apertures adapted to allow a user to engage the female socket component with an implement adapted to release the Morse taper friction fit; and
a prosthesis affixed to an exterior surface of the female socket component using a third Morse taper.
